(19) United States
(12) Patent Application Publication
(10) Pub. No.: US 2006/0265891 A1
(43) Pub. Date: Nov. 30, 2006

(54) Torpedo level for use with plastic pipe

(76) Inventor: Kevin Murphy, Skaneateles, NY (US)

Correspondence Address: WALL MARJAMA & BILINSKI, 101 SOUTH SALINA STREET, SUITE 400, SYRACUSE, NY, 13202, US

(21) Appl. No.: 11/135,870

(22) Filed: May 24, 2005

(51) Int. Cl. G01C 9/24

(52) U.S. Cl. 33/379

(57) ABSTRACT

A torpedo level is adapted for use with a non-metallic material such as PVC pipe by providing an attachment device for temporarily affixing the torpedo level in engaging relationship with the plastic pipe without any attendance. In one embodiment, the affixing device is an attachment strip extending along a planar side of the torpedo level and having an adhesive material on its outer side. A cover is adapted to protect the adhesive material when not in use. Another attachment device is a plurality of suction cups which are secured to the planar side and temporarily attachable to a plastic pipe. Another alternative is one or more Velcro straps which are attached to the body of the torpedo level by way of slots formed therein and which are selectably wrapped around a pipe for securing the torpedo level thereto.

### BACKGROUND OF THE INVENTION

This invention relates generally to plumbing tools and, more particularly, to a torpedo level for use with plastic pipes.

In the plumbing industry, the angular disposition of pipes that are installed in a building is important because the flow characteristics of the liquid being carried by the pipes are affected. Further, since the structural components of the building itself are established along horizontal and vertical lines, the plumbing components are preferably installed in this manner so as to maintain compatibility therewith. The manner in which a plumber commonly ensures the proper angular orientation of plumbing being installed is by way of a torpedo level.

In the past, the material used for piping installed in buildings was most commonly a metallic material such as galvanized pipe or black iron pipe. Accordingly, a common design for a torpedo level was to have a magnetic material embedded in or attached to one or more of the planar surfaces on the torpedo level such that when installing a pipe, the plumber could simply magnetically attach his torpedo level to the pipe and leave it there until the pipe had been fixed in place, after which the plumber would simply remove the torpedo level and place it back in his pocket or tool kit.

With the advent of plastic pipes such as those made from a poly-vinyl chloride or acrylonitrile butadiene styrene (ABS) material, the torpedo level with the magnetic siding can no longer be affixed to the pipe. Therefore it has been necessary for the plumber or an assistant to hold the torpedo level in place until the pipe has been fixed in its position. This procedure then allowed only one free hand for the plumber, thereby substantially reducing his productivity.

### SUMMARY OF THE INVENTION

Briefly, in accordance with one aspect of the invention, provision is made for temporarily attaching a torpedo level to a plastic pipe so that the plumber is free to use both hands in the installation process without the need to hold the torpedo level in place.

By yet another aspect of the invention, an adhesive material is installed on a planar edge of a torpedo level such that the torpedo level can be temporarily affixed to a plastic pipe and will remain in place during the installation process. The adhesive may be of a soft cleaning type, or a cover may be provided to protect the adhesive during periods of nonuse.

By still another aspect of the invention, the torpedo level may include other attachment means such as one or more suction cups that can be attached directly to the pipe or one or more Velcro straps that maybe wrapped around the pipe to secure the torpedo level in place.

In the drawings as hereinafter described, a preferred embodiment is depicted; however, various other modifications and alternate constructions can be made thereto without departing from the true spirit and scope of the invention.

### BRIEF DESCRIPTION OF THE DRAWINGS

FIG. 1 is a front view of a torpedo level in accordance level with one embodiment of the invention.

FIG. 2 is a front view of the torpedo level as affixed to a plastic pipe in accordance with the present invention.

FIG. 3 is a front view of the torpedo level as applied to a plastic pipe in a vertical orientation.

FIG. 4 is a front view of an alternative embodiment of the present invention.

FIG. 5 is a front view of yet another alternative form of the present invention.

### DETAILED DESCRIPTION OF THE INVENTION

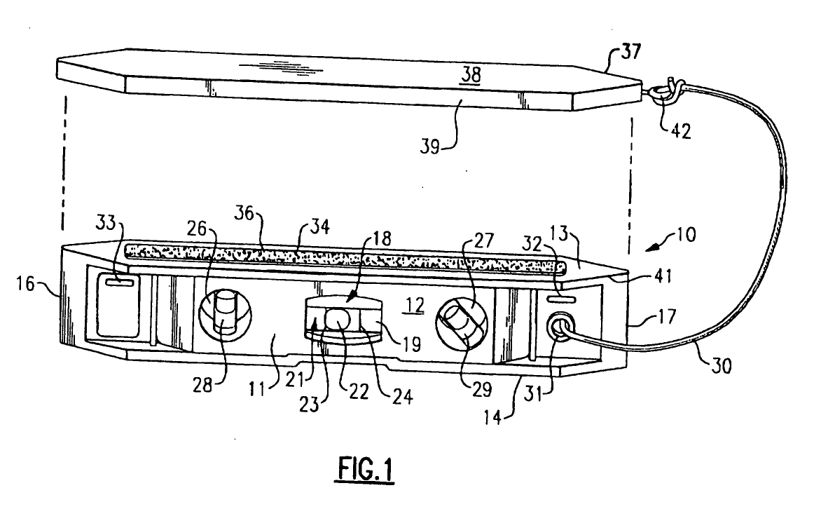

Referring now to FIG. 1, the torpedo level in accordance with the present invention is shown generally at 10 to include an elongate body 11 with front face 12, a rear face (not shown), a top edge surface 13, a bottom edge surface 14, and ends 16 and 17. The front face 12, the top edge surface 13 and the bottom edge surface 14 are generally rectangular in shape, but near the ends 16 and 17, the top edge surface 13 and bottom edge surface 14 are tapered down to an edge at the end 16 and 17 as shown. The tapered feature is provided for convenience in placing the level into a plumbers pocket or work pouch.

In the middle of the front face 12 is an opening 18 which passes through the elongate body 11, and mounted longitudinally within the opening 18 is a glass cylinder 19 which is filled with a liquid 21 having a bubble 22 therein. A pair of lines 23 and 24 are drawn in a transverse direction across the glass cylinder 19 to provide a reference for determining the position of the bubble 22. As is conventional in the use of levels, when the top edge surface 13 and the bottom edge surface 14 are placed in a horizontal position a bubble 22 will remain in a midpoint of the glass cylinder 19, or centered between the two lines 23 and 24.

In a similar manner, the openings 26 and 27 are formed through the body 11 and have respective glass cylinders 28 and 29, which are also filled with liquid and have a bubble therein. The glass cylinder 28 is disposed in a transverse orientation as shown, such that when the top edge surface 13 and bottom edge surface 14 are placed in a vertical orientation, the bubble within the glass cylinder 28 is centered.

The glass cylinder 29 is disposed in an oblique orientation as shown such that, when the top edge surface 13 and the bottom edge surface 14 are placed in at angle of 45° with respect to the horizontal, the bubble within the glass cylinder 29 is centered.

Near the one end 17 of the body 11 there is provided a hole 31 for use in hanging up the torpedo level on a hook or the like. It may also be used for attachment to a lanyard 30 for use as will be described hereinafter. Also provided is a slot 32 at one end 17 and another slot 33 near the other end 16 for use with securing straps if desired as will be more fully described hereinafter.

Attached to the top edge surface 13 is an attachment strip 34 that extends longitudinally along most of the length of the top edge surface 13. The attachment strip 34 maybe secured to the top edge surface 13 by any suitable means such as by an adhesive, by one or more fasteners such as screws, or by frictional means such as sliding it into a retaining slot in the top edge surface 13, for example. Disposed on the top surface of attachment strip 34 is an adhesive 36 which will allow a temporary attachment of the attachment strip 34, and hence the torpedo level, to a non-metallic component such as a plastic pipe. The adhesive material 36 is preferably of a type which can be periodically cleansed or rejuvenated so as to maintain its adhesive nature following periods of use. One possible approach is to use a double-sided adhesive with one side secured to the edge surface 13 and the other side to the pipe. It may also be desirable to apply a longer lasting and more permanent type of curable adhesive to secure the strip to the torpedo level.

Recognizing that during periods of nonuse the adhesive material 36 is likely to be in contact with other surfaces and therefore tend to become dirty and less able to adhere to other surfaces, a cover 37 is provided to fit over the top edge surface 13, and thereby cover and protect the attachment strip 34. The cover 37 preferably has a top element 38 and side elements 39 which extend downwardly therefrom to generally define a cavity for encapsulating the attachment strip 34, with the sides 39 extending over the edges 41 of the top edge surface 13. The adhesive then holds the cover in its closed position. An eye hook 42 is attached to one end of the cover 37 for attachment to the torpedo level by way of the lanyard 30.

In practice, the cover 37 is maintained in its installed position so as to cover and protect the attachment strip 34. When it is desired to use the torpedo level, the cover 37 is removed and allowed to dangle from the lanyard 30 while the torpedo level is installed on a pipe. After use, the torpedo level is removed from the pipe and the cover is return to the installed position so that the torpedo level can be returned to its storage place such as in the pocket of the plumber or to a toolbox.

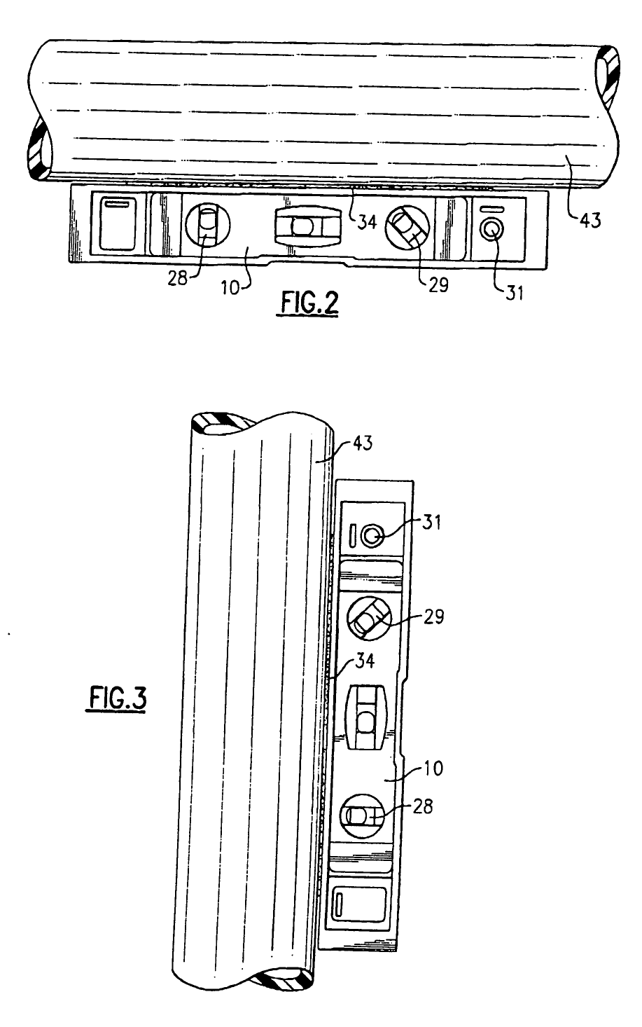

Referring now to FIG. 2, the torpedo level 10 is shown in its installed position below a plastic pipe 43. As will be seen, the attachment strip 34 has been pressed against the lower surface of the pipe 43 so as adhesively adhere thereto and, in turn, support the torpedo level 10 in its installed position. While in this position, the torpedo level 10 can be left unattended while the pipe is moved into a desired position (e.g. in a horizontal position), and fixed in place. The torpedo level 10 can then be removed and, if desirable, the cover 37 can be installed over the attachment strip 34 as described hereinabove.

Although shown in a position below the pipe 43, it should be understood that the torpedo level 10 could just as well placed in a position on the upper surface of the pipe 43 if there is sufficient room to do so.

Shown in FIG. 3 is a torpedo level as applied in a vertical orientation in accordance with the present invention. In this case it is the glass cylinder 28 which is used to determine the actual orientation.

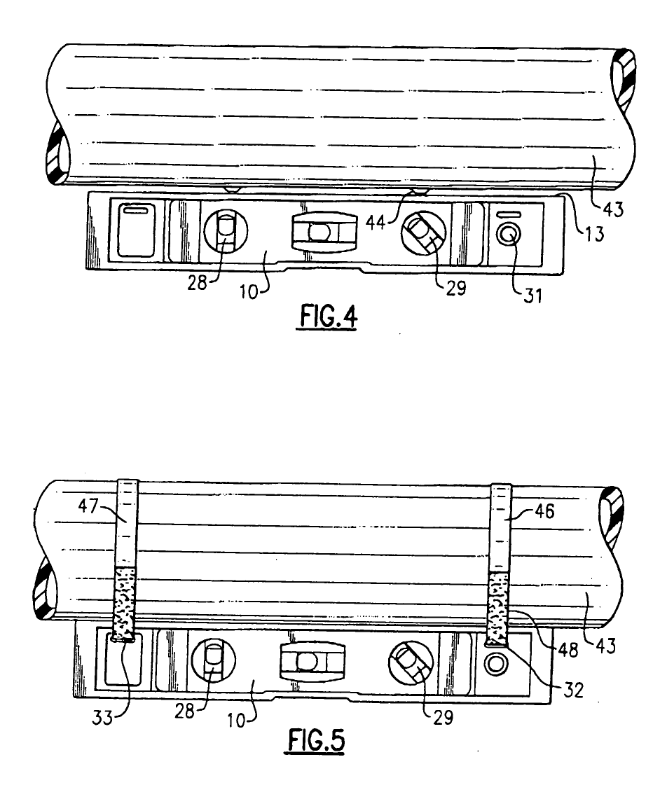

An alternative embodiment of the invention is shown in FIG. 4 wherein, rather than the attachment strip 34 adhesively attaching the torpedo level 10 to the pipe 43, a plurality of suction cups 44 are attached to the top edge surface 13 as shown, with the suction cups 44 then being temporarily attached to the plastic pipe 43 during use. The suction cups 44 are therefore attached to the torpedo level 10 on a more permanent basis such as by a adhesive or by fasteners, brazing or welding, whereas the then exposed portions of the suction cups 14 are adapted to be temporarily affixed to the pipe 43 and therefore can be easily removed after installation of the pipe 43.

Another embodiment of the present invention is shown in FIG. 5 wherein the torpedo level 10 is secured by a pair of straps 46 and 47 which pass through the slots 32 and 33, respectively and are temporarily wrapped around the pipe 43 as shown. In order to facilitate the quick and easy attachment and disattachment of the straps 46 and 47, a Velcro material 48 is preferably used. When the torpedo level 10 is not being used, the straps 46 and 47 remain in their positions within the respective slots 32 and 33, and can then easily be attached to a pipe whenever use is desired.

Although the torpedo level 10 has been shown and described as being used with a pipe 43 placed in the horizontal position, it should be understood that the device can also be used for the installation of pipes in other orientations. For example, for vertical pipe orientations, the torpedo level 10 can be placed on the one side of the pipe so as to be in a vertical orientation, in which case the glass cylinder 29 is used as an indicator of the orientation of the pipe. Similarly, if the pipe is to be oriented at a 45° angle, the torpedo level 10 can be placed above or below the pipe and the glass cylinder 29 can be used as an indicator of its orientation.

While the present invention has been particularly shown and described with reference to preferred and alternative embodiments as illustrated in the drawings, it will be understood by one skilled in the art that various changes in detail maybe effected therein without departing from the spirit and scope of the invention as defined by the claims.

1. A leveling device for engagement with a planar surface of a non-metallic construction component for sensing and adjusting the angular orientation of the construction component, comprising:
a body having at least one planar surface on one longitudinal side thereof;
at least one liquid filled elongated bulb mounted in said body and having a bubble therein, said bulb being so disposed that when said at least one planar surface is in a horizontal disposition, the bubble is centered within said bulb; and
means for temporarily securing said body planar surface in aligned engagement with the planar surface of the construction component wherein said securing means comprises an attachment strip attached to said body planar surface and having an adhesive material on its outer side for temporary attachment to said construction component and including a cover for removeably covering said attachment strip.

2. A leveling device as set forth in claim 1 wherein said construction component is a plastic pipe.

3. A leveling device as set forth in claim 1 wherein said at least one liquid filled elongate bulb includes a second liquid filled elongated bulb having a bubble therein and being disposed at a 90° orientation with respect to a first liquid filled elongated bulb.

4. A leveling device as set forth in claim 1 wherein said at least one liquid filled elongated bulb includes a third liquid filled elongated bulb having a bubble therein and oriented at an angle of 45° with respect to a first liquid filled elongated bulb.

5. (canceled)

6. A leveling device as set forth in claim 1 wherein said attachment strip is attached to said body planar surface by way of an adhesive material.

7. (canceled)

8. (canceled)

9. (canceled)

10. (canceled)

11. (cancelled)

12. A device for indicating the longitudinal deviation of a plastic pipe from a horizontal plane, comprising:
a body having at least one planar side adapted to be placed in engaging relationship with the longitudinal outer side of the plastic pipe;
at least one elongated closed housing disposed within said body and filled with a liquid having an air bubble therein, said housing being so oriented in said body that said air bubble is in an intermediate position when said body planar side is in a horizontal position; and
means for temporarily affixing said body planar side to a longitudinal outer side of the plastic pipe wherein said affixing means comprises an attachment strip attached to said planar side and having an adhesive on its outer side for temporary attachment to the pipe and including a cover to be temporarily placed over said attachment strip to protect the adhesive material during periods of nonuse.

13. (canceled)

14. (canceled)

15. (canceled)

16. (canceled)

17. (canceled)

18. (canceled)

19. A method of temporarily securing a torpedo level to a non-metallic construction component wherein the torpedo level includes a body with a planar side and with at least one liquid filled elongated bulb mounted in the body and having a bubble therein, comprising the steps of:
securing an attachment device to said body, with the attachment device having a mating portion which is connectable to the plastic pipe for temporary periods such that the torpedo level will remain secured to the plastic pipe without being attended wherein said attachment device comprises an attachment strip extending over a portion of the length of the planar side and having on its outer side, an adhesive material for adhering to the plastic pipe: and removing said body and its attachment device from it adherence to the plastic pipe and providing a cover to be temporarily placed over said attachment strip to protect the adhesive material during periods of non-use.

20. (canceled)

21. (canceled)

22. (canceled)

23. (canceled)
